(19) United States
(12) Patent Application Publication
(10) Pub. No.: US 2014/0028662 A1
(43) Pub. Date: Jan. 30, 2014

(54) VIEWER REACTIVE STEREOSCOPIC DISPLAY FOR HEAD DETECTION

(71) Applicants: Miao LIAO, Camas, WA (US); Chang YUAN, Seattle, WA (US)

(72) Inventors: Miao LIAO, Camas, WA (US); Chang YUAN, Seattle, WA (US)

(73) Assignee: Sharp Laboratories of America, Inc., Camas, WA (US)

(21) Appl. No.: 13/556,624

(22) Filed: Jul. 24, 2012

(51) Int. Cl. G06T 15/00

(52) U.S. Cl. 345/419

(57) ABSTRACT

An auto stereoscopic display includes a plurality of views thereby providing a perceived three dimensional image to a viewer. The display includes a sensor that determines the position of the viewer with respect to the display and modifies the plurality of views to provide an improved perceived three dimensional image to the viewer.

### CROSS-REFERENCE TO RELATED APPLICATIONS

None.

### BACKGROUND OF THE INVENTION

The present invention relates to stereoscopic displays.

Stereoscopic three dimensional (3D) displays are increasing in popularity together with the growth of available three dimensional content. Stereoscopic displays present stereoscopic images by adding the perception of three dimensional depth, often without the use of special headgear or glasses on the part of the viewer. Auto stereoscopic displays do not require headgear, also sometimes referred to as “glasses-free 3D” or “glasses-less 3D”. Since they do not require the viewers to wear glasses and they generate multiple (usually more than two) views for viewers' left and right eyes, this results in three dimensional human depth perception. They are suited for various applications, including digital signage, televisions, monitors, and public information. Some auto stereoscopic displays include parallax barrier type displays, lenticular type displays, volumetric type displays, electro-holographic type displays, and light field type displays.

One of the challenges of existing auto stereoscopic displays is achieving high quality three dimensional images for the viewer. There are certain areas in the viewing space in front of an auto stereoscopic display that are optimal for three dimensional depth perception, generally referred to as “optimal viewing zones” or “sweet spots.” Viewers outside sweet spots, however, will observe sub-optimal-quality three dimensional images. In some cases, the three dimensional images may appear to have reversed views (namely the viewer's left eye sees the right view and the right eye sees the left view). If the viewers are not at the optimal viewing distance (e.g., too close to the display), the three dimensional images may also contain multiple views that generates blurry or tearing images. In addition, the level of cross talk (one view leaking into another view) also varies when viewers move in front of the display. What makes such issues even more problematic is the limited flexibility of human visual system, especially the stereoscopic vision system, that viewers may not notice the problems in the three dimensional images right away. Thus, viewers tend to stay in a wrong position for an extended period of time and may or may not realize that the image is incorrect. During this process, however, viewers may already experience visual discomfort and fatigue, due to the sub-optimal three dimensional viewing experience.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a technique for viewer reactive displays.

FIG. 2 illustrates multiple cone-shape views from a display.

FIGS. 3A and 3B illustrate original viewing zones and optimal viewing zones.

FIG. 4 illustrates a technique for measuring viewing zones of the display.

FIG. 5 illustrates images with individual viewing zone numbers.

FIG. 6 illustrates a final multi-view calibration pattern image.

FIG. 7 illustrates a process for viewing zone measurement.

FIG. 8 illustrates labeled optimal viewing zones for a display.

FIG. 9 illustrates a process for viewer detection, tracking, and improved viewing.

FIG. 10 illustrates face detection and segmentation.

FIG. 11 illustrates Haar-like feature based object detection.

FIG. 12 illustrates template matching based on eye tracking.

FIG. 13 illustrates image formation.

FIG. 14 illustrates a discrete Kalman filter cycle.

FIG. 15 illustrates reversed viewing on a display.

FIG. 16A and FIG. 16B illustrate optimal single viewing zone and mixed viewing zones.

FIG. 17 illustrates adjusting multi-view images to improve three dimensional viewing.

FIG. 18 illustrates switching views to solve the reversed viewing on auto stereoscopic displays.

FIG. 19 illustrates instructing viewers to move to an improved viewing position.

### DETAILED DESCRIPTION OF PREFERRED EMBODIMENT

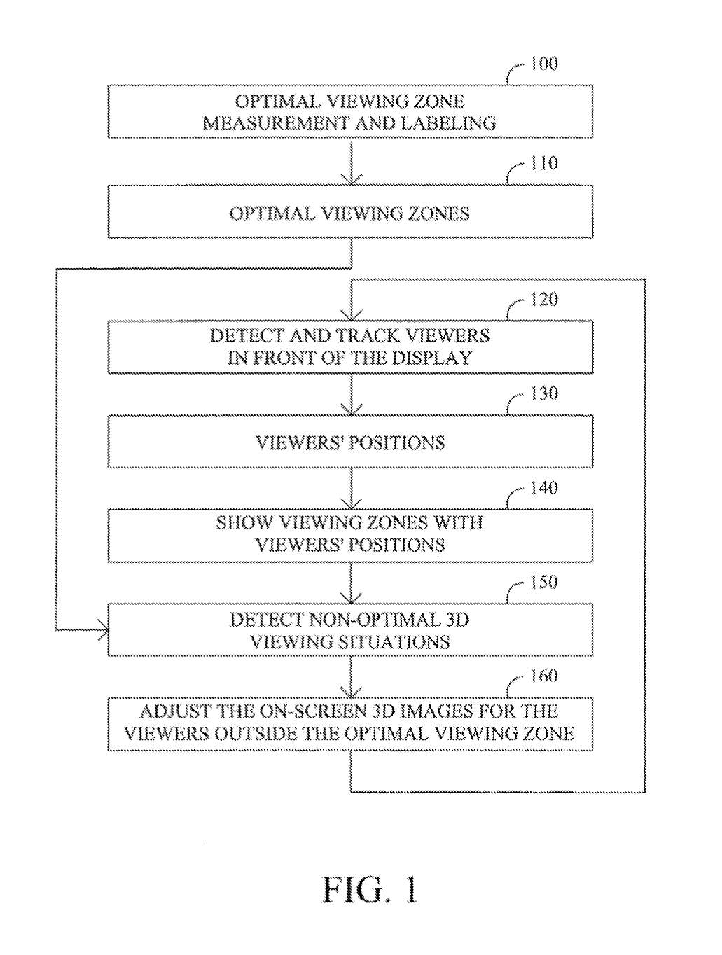

Referring to FIG. 1, it is desirable to improve the ability of the viewer to be in the sweet spot by including reactive capabilities, especially in the case of an auto stereoscopic display. A display measurement process 100 may be conducted to characterize the viewing zones 110 in front of the display. In particular, the display measurement process 100 may evaluate the perceived multiple views at different positions in front of the display by moving a camera in front of the display and labeling optimal viewing zones for the display. This process may be done before the viewer uses the display.

While the viewer is viewing the display, a viewer detection and tracking process 120 may be used to determine the location of one or more eyes of one or more viewers in front of the display. The viewer detection and tracking process 120 may generate a depth map by using a three dimensional sensor associated with the display. Preferably the three dimensional sensor is integrated with the display or otherwise maintained in a fixed position with respect to the display. The viewer detection and tracking process 120 provides the location(s) of one or more of the eyes of the viewer's positions 130. The display may show the optional viewing zones on the display together with an indication of the eyes corresponding to the viewer's position(s) 140 and/or where to relocate to. In this manner, the viewer may be directed to relocate themselves from a non-optimal viewing zone to a more optimal viewing zone or otherwise the image content is modified for improved viewing. The detected eye positions 130 are compared 150 to the optimal viewing zones 110 in front of the display. If one or more viewers is determined to be in a sub-optimal zone, the display may react to this situation by adjusting the on-screen images to provide more optimal three dimensional images for one or more viewers. For example, if a particular viewer occupies a zone by himself, the display may adjust the views so that the two views the viewer sees are corrected and lead to a more optimal three dimensional depth perception. For example, if two or more viewers occupy different zones, the display may adjust the views so that the two views that each of the viewer sees are corrected and lead to a more optimal three dimensional depth perception. For example, if the viewer shares one or more viewing zones with other viewers, the display may not be capable of adjusting the image without adversely affecting the other viewers. In this case, the display preferably shows a visual message 140 to notify one or more viewers to move to a nearby unoccupied position in order to achieve an improved viewing experience or otherwise reverts to showing a two dimensional image.

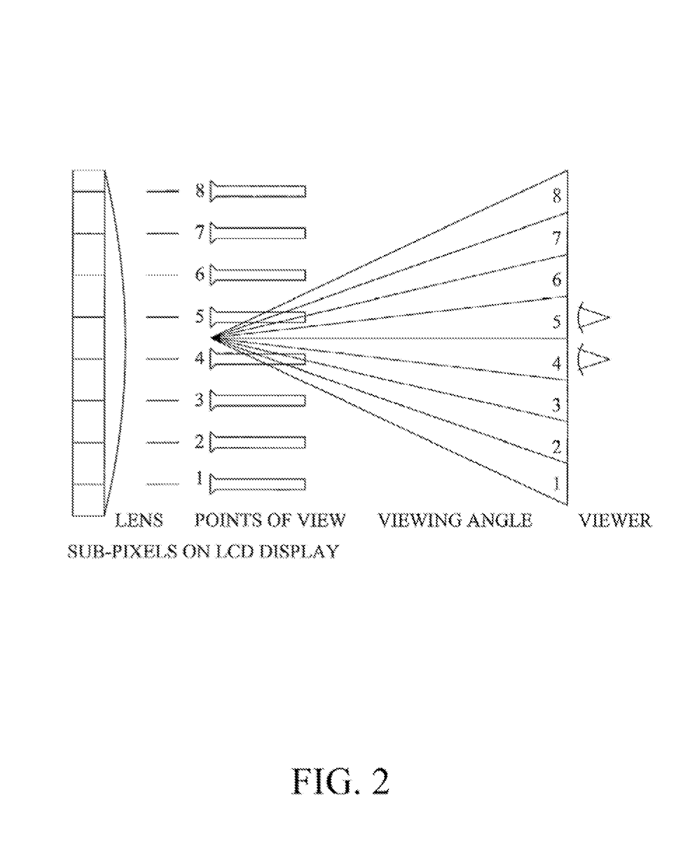

The display measurement process 100 may estimate the visible viewing zones at a plurality of locations in front of the display. Many auto stereoscopic displays generate multiple cone-shaped views in the three dimensional space in front of the display. Referring to FIG. 2, the three dimensional display ideally generates clearly separated views for each eye, which leads to ideal three dimensional vision when the viewer is in the appropriate position. Unfortunately, actual auto stereoscopic displays do not generate such a simplistic viewing layout. Instead, the cone for each view tends to intersect with all the other ones and generates a common area where viewers can see multiple views from their eyes.

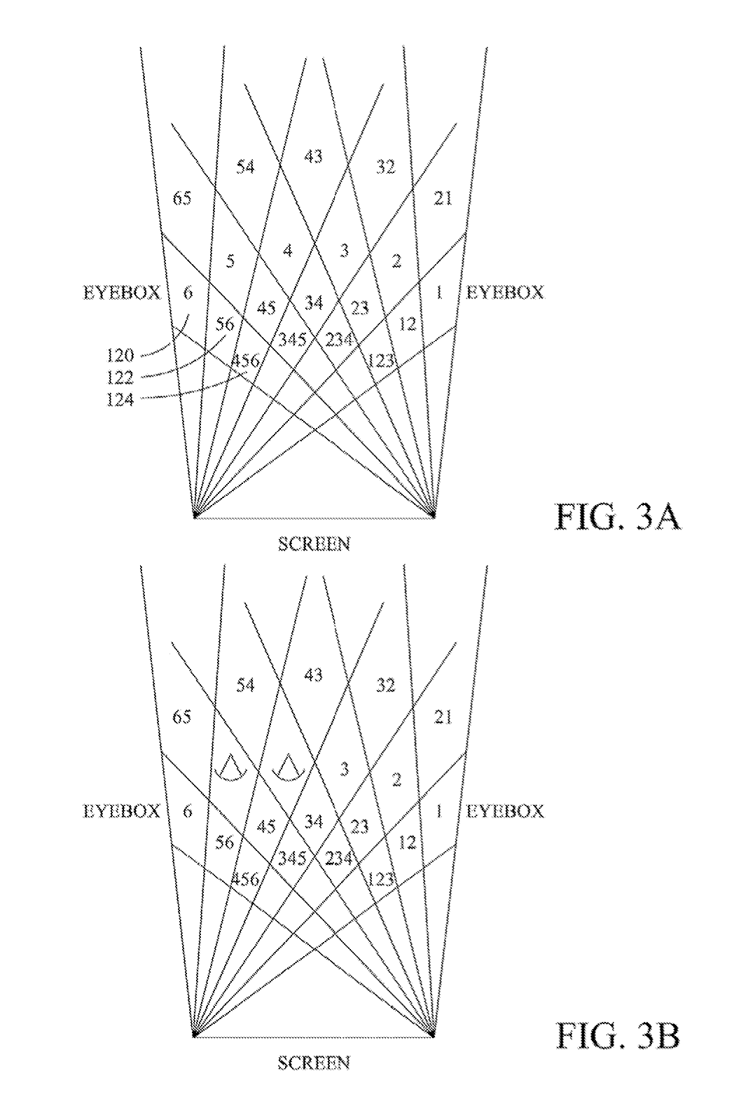

Referring to FIG. 3A, each viewing zone may contain 1, 2, 3 or more views. For example, location 120 includes primarily view number 6. For example location 122 includes primarily views 5 and 6. For example, location 124 primarily includes views 4, 5, and 6. To provide a more pleasant viewing experience, the viewers should be in a location where each eye can only see a single view. Referring to FIG. 3B, the viewer's left eye observes view 4 and the viewer's right eye observes view 5. View 4 is intended for the observer's left eye and view 5 is intended for the observer's right eye. The two views are different from one another and therefore viewers can obtain a three dimensional depth perception. The preferable optical viewing zones are those zones across the center of the region with a single view contained therein. Typically, the views for each eye are spaced apart from one another by the distance between the eyes.

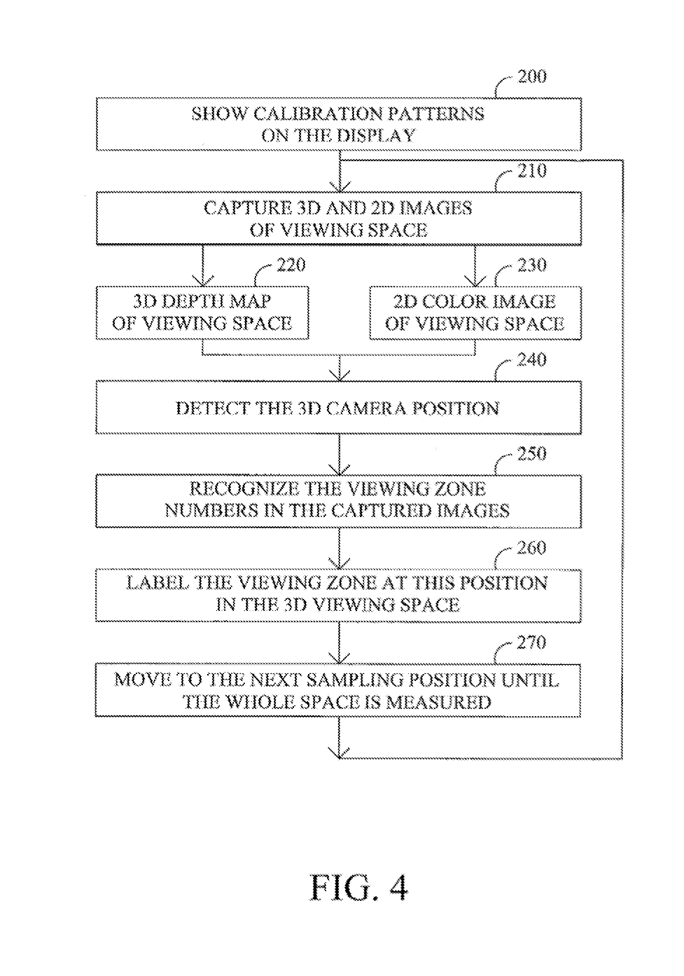

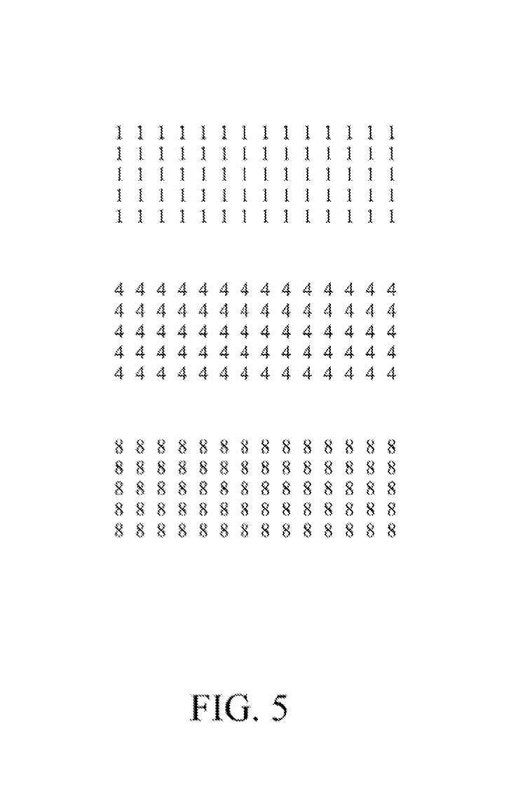

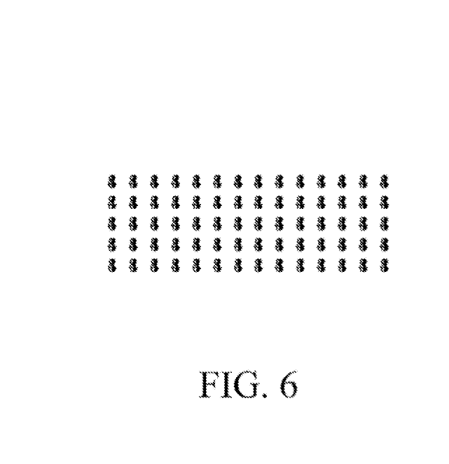

Referring to FIG. 4, one technique to characterize the viewing zones in front of the display is to show calibration patterns on the display 200. The pattern may consist of multiple views (e.g., in total 8 views), each of which is rendered with the view number by a computer. For example, FIG. 5 illustrates a number of images that are shown with their viewing zone numbers. For example, FIG. 6 illustrates a resulting final composite pattern image.

The display may capture three dimensional images of the viewing space and two dimensional images of the viewing space 210. Based upon these captured images of the viewing space 210, the system may determine a three dimensional depth map of the viewing space 220 and a two dimensional color image of the viewing space 230. Based upon the three dimensional depth map 220 and the two dimensional color image 230 the system may determine the three dimensional camera position 240 as the camera is moved in front of the display. The system may recognize the viewing zone number(s) in the captured images 250 and equate that to the location of the camera. Based upon the recognized numbers the system may label the viewing zone at each position in the three dimensional viewing space 260. The camera is moved to all desired sampling positions until the entire space is sufficiently measured 270.

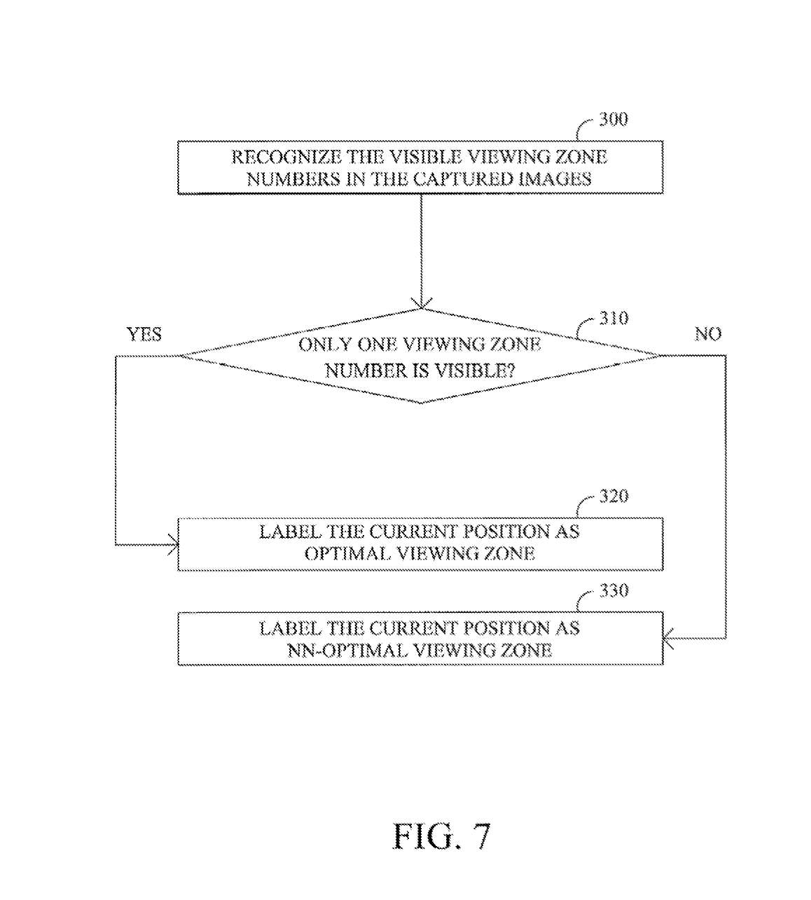

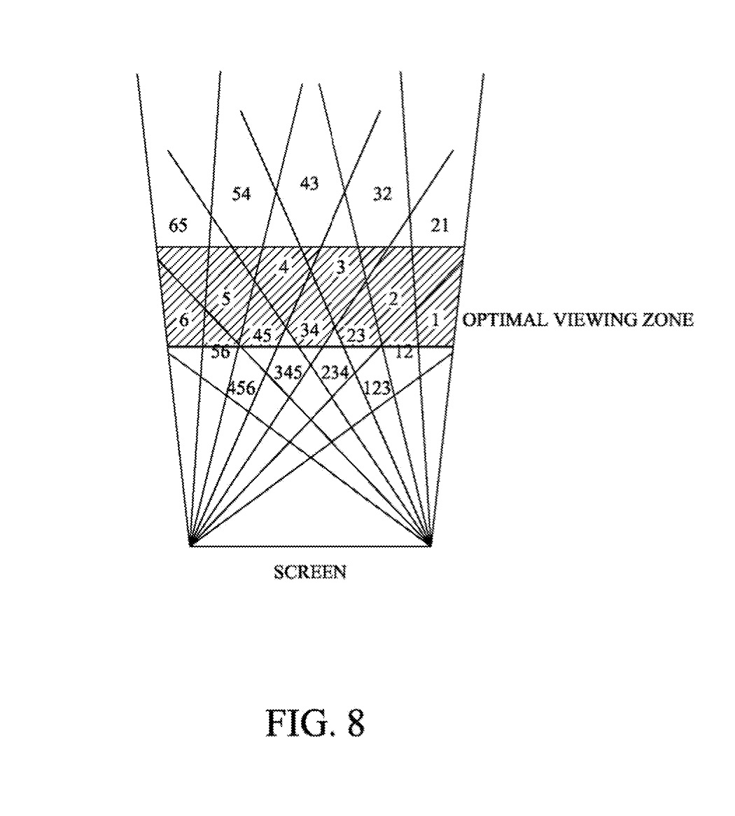

When the camera is moved in front of the display, the images captured by the camera are preferably analyzed by an image pattern matching process. The process, as illustrated in FIG. 7, includes template matching over the captured images and determines matches of the computer generated numerical patterns. In other words, the process first recognizes the visible viewing zone numbers in the captured images 300. The set of viewing zone numbers is searched and the possibility of each number pattern being visible at a certain position is summarized. The process may determine if only one viewing zone number is visible for a particular location 310. Those locations that only include a single zone number are labeled as optimal viewing zones 320. Those locations that include more than a single zone number are labeled as non-optimal viewing zones 330. In this manner, those locations with preferred views and those locations with non-preferred views are identified. The system may further characterize the viewing zones as having two or more zone numbers and the numbers therein. Referring to FIG. 8, a set of exemplary optical viewing zones are illustrated. Typically, the optical viewing zones are in the middle range of the viewing space in front of the display. Viewers are then recommended to stay within this zone in order to perceive improved three dimensional images.

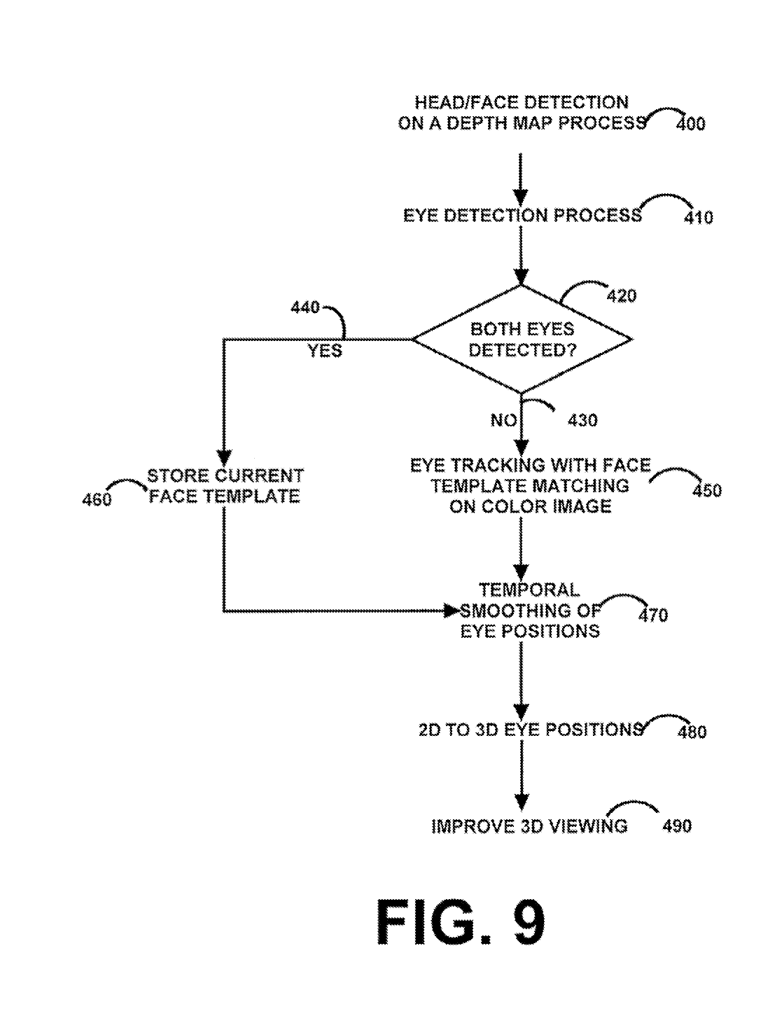

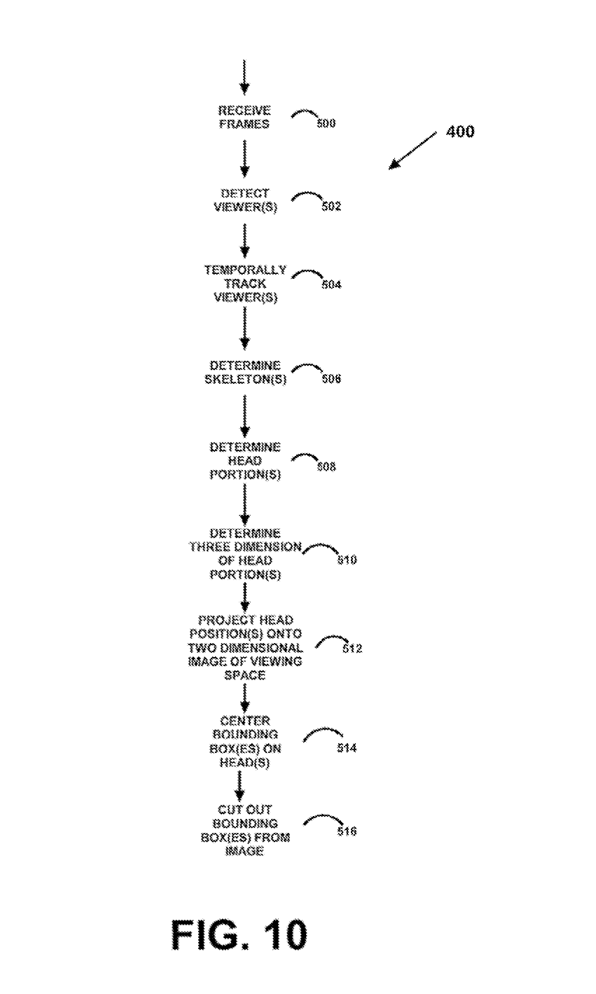

Referring to FIG. 9, it is desirable to include a technique that explicitly tracks the eyes of the viewer(s) in three dimensional space using a computationally effective technique so that the position of the viewer to the display may be known together with their distance from the display, so that the images on the display may be rendered more appropriately. The imaging device associated with the display may capture three dimensional images of the viewing space to identify the head and face regions of the viewer(s) on a depth map 400. Referring also to FIG. 10, one technique to detect the head and/or face of the viewer(s) on the depth map 400 includes receiving one or more frames 500 of the viewing space. The system detects one or more viewers in the frames 502. The one or more viewers in the frames 502 may be temporally tracked 504. The system may also determine a skeleton for each of the one or more viewers 506 which is more computationally efficient for subsequent processing. Each skeleton, for example, may be represented as multiple points connected by lines and/or surfaces. The head portion of each of the skeletons is determined 508. The three dimensional position of each of the head portions 510 may be determined and projected back onto a two dimensional color image of the viewing space 512. A bounding box(s) is centered at each of the projected head position(s) 514. The size of the bounding box is inversely proportional to the viewer's distance to the sensor. The image region within the bounding box may be cut out (or otherwise selected) 516 as the sub-image of the viewer's head/face.

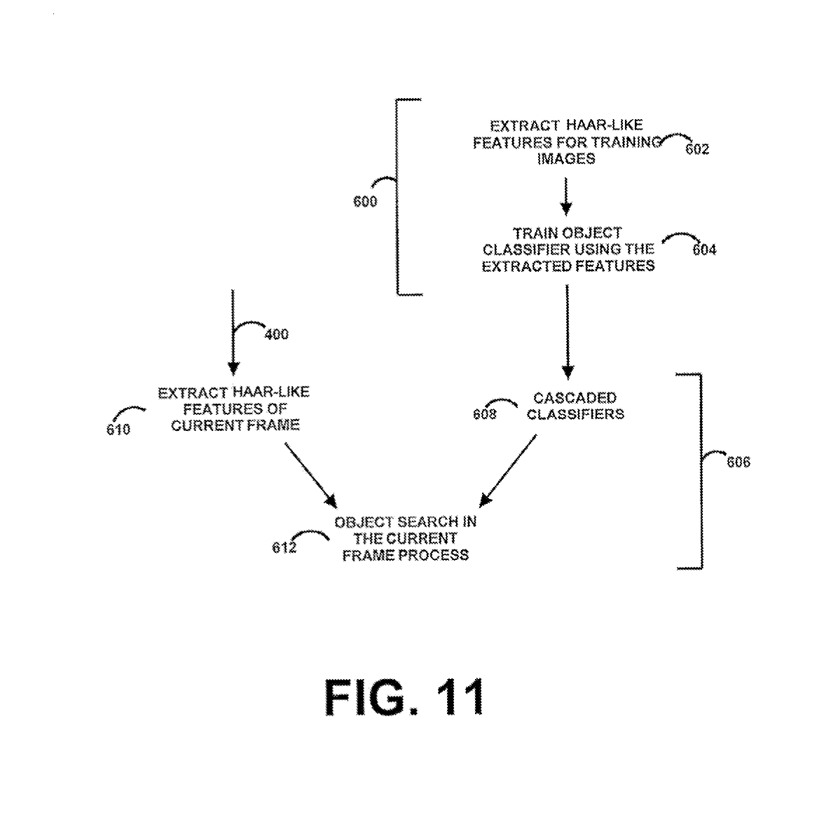

Referring again to FIG. 9, the output of the head/face detection 400 is provided to an eye detection process 410. Referring to FIG. 11, a Haar-like feature detection process may be used to detect the position of the eyes of the viewer(s) in the three dimensional space in a computationally efficient manner. A set of objects, such as faces and eyes, may be used to train 600 the system for subsequent classification. The training 600 is preferably done off-line. Initially, Haar-like features are extracted from the training images 602. Those extracted features 602 are used to train a classifier 604 which is used by a classification process 606. In the classification process 606, the classifier 604 may be arranged as a set of cascaded classifiers 608. In the classification process 606, the Haar-like features in the head/face region(s) of each frame may be extracted 610. The Haar-like extracted features 610 are applied to the cascaded classifiers 608, such as using an object search in the current frame process 612, to determine if the target object likely exists in the frame.

The classifiers 604 and/or cascaded classifiers 608 may be designed to detect both eyes simultaneously, which is desirable since two eyes contain more features than a single eye, making the classifier more distinctive and robust to false positive detections. The output is the location of the detected eye pairs or none if nothing is detected.

Referring again to FIG. 9, if the eye detection process 410 fails 430 to detects both eyes 420 then an eye tracking with face template matching process on the color image 450 may be used. One technique is to store images of the eyes and to search for them in the face image once the detection fails. However, in many cases, the images of the eyes are quite small, typically less than 10 pixels in width, resulting in a lack of distinctive features. Thus searching using an eye template within a face image tends to lead to quite a lot of false positives, such as nose, mouth, ear, and hair. Accordingly, it is more desirable to match the faces, which tend to be more robust, even if there is a slight rotation between the two faces being matched.

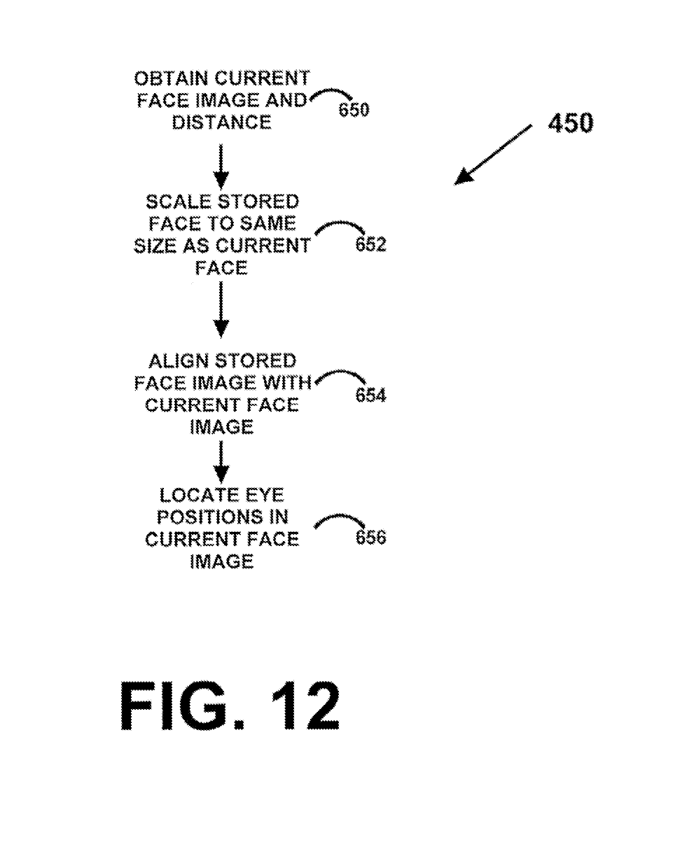

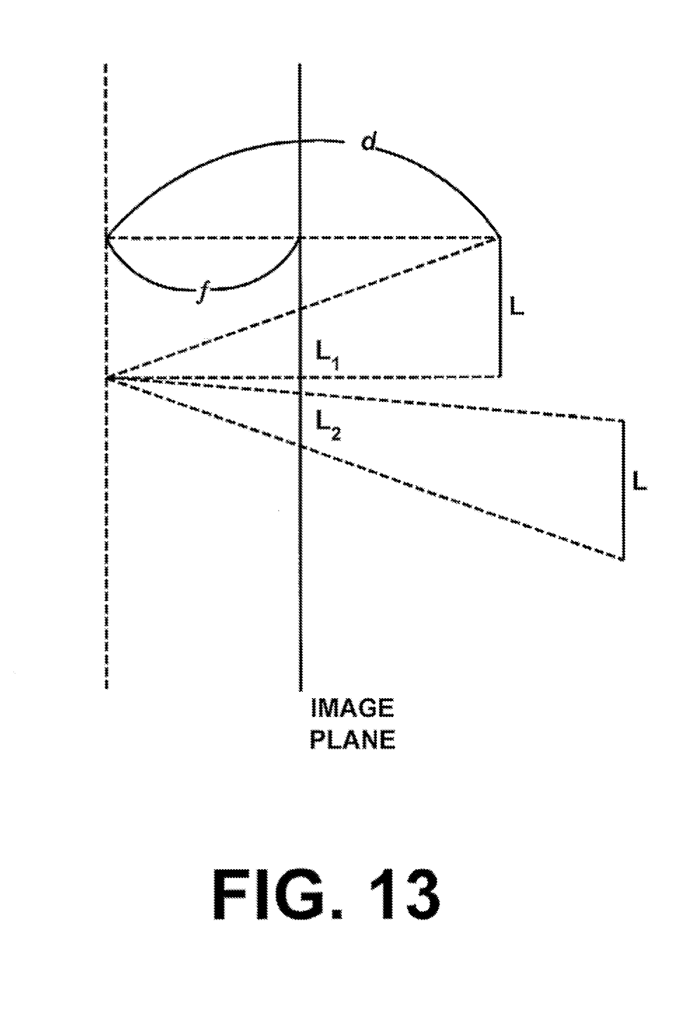

If a pair of eyes is not successfully detected in the face sub-image 430, the system may use a template matching process using the color image based upon eye tracking 450. Referring also to FIG. 12, the eye tracking process 450 may include, for example, extracting the current face sub-image and face distance 650, and compare it with a previously stored face image. One issue is that the stored face image is usually captured when the viewer is close to the sensor and eye detection failure tends to happen when the viewer is further away to the sensor. That means that the stored face image might be bigger than the current face image 652. Thus, the system may scale the stored image to the same size as the current face image. The scaling factor may be readily obtained given the distance of both faces. As illustrated in FIG. 13, the image size of an object is inversely proportion to its depth,

$${L}_{1} = \frac{f}{{d}_{1}} L , {L}_{2} = \frac{f}{{d}_{2}} L ,$$

where f is the focal length of the sensor, d is the object distance to the camera center, and L is the size of the object. From this equation, the ratio of the image sizes is the inverse of the ratio of their distances,

$$\frac{{l}_{1}}{{l}_{2}} = \frac{{d}_{2}}{{d}_{1}} .$$

Subsequently, me scaling factor of the stored face image may be computed as the ratio of the distances.

After the sizes of the face images are modified, or otherwise accounted for, the system may align the stored face image with the current face image 654. The alignment may be performed by computing a similarity score between the current face image template and the candidate face template of the same size. The similarity score S may be computed as a normalized cost correlation

$$S = \frac{{\sum }_{x , y} T ( x , y ) \cdot I ( x , y )}{\sqrt{{\sum }_{x , y} {T ( x , y )}^{2} \cdot {\sum }_{x , y} {I ( x , y )}^{2}}} ,$$

where T(x,y) is the pixel value at (x,y) in the template face image and |(x,y) is the pixel value at (x,y) in the candidate template. After the similarity scores are computed for all the candidate templates, the template with the maximum score is selected to be a match, and the current face image is translated to be aligned with its match. Once the alignment is completed, the eye positions may be directly transferred to the current face image 656.

If a pair of eyes is successfully detected in the face sub-image 440, the system may store this face image, relative eye positions within the sub-image, and/or the depth of the face as a positive match 460.

The resulting eye position(s) may be temporally smoothed 470 to reduce the effects of image noise, illumination changes, motion blur, and other factors that may shift the detected eye positions from its true locations. Thus, temporally smoothing tends to enforce some temporal coherence constraints on the eye position trajectories to result in a smoother eye motion. One temporal smoothing technique is Kalman filtering. The Kalman filter addresses the general problem of trying to estimate the state x of a discrete-time controlled process that is governed by the linear stochastic difference equation, xₜ=Axₜ₋₁+Buₜ₋₁+wₜ₋₁. A measurement z may be defined as, zₜ=Hxₜ+vₜ. x is the state vector to be estimated and t is the discrete time stamp. For example, x may be a 4×1 vector [u v dᵤ dᵥ] including eye position and eye velocity. Both eyes have their only state state vector. The 4×4 matrix A relates to the state at the previous time step t−1 to the state at the current step t,

$$A = [ \begin{matrix}1 & 0 & 1 & 0 \\ 0 & 1 & 0 & 1 \\ 0 & 0 & 1 & 0 \\ 0 & 0 & 0 & 1\end{matrix} ] .$$

The 4×n matrix B relates to the optimal control input u to the state x. For example, the u matrix may be 0. The 2×4 matrix H is a measurement equation that relates the state to the measurement z to the detected 2 dimensional eye position,

$$A = [ \begin{matrix}1 & 0 & 0 & 0 \\ 0 & 1 & 0 & 0\end{matrix} ] .$$

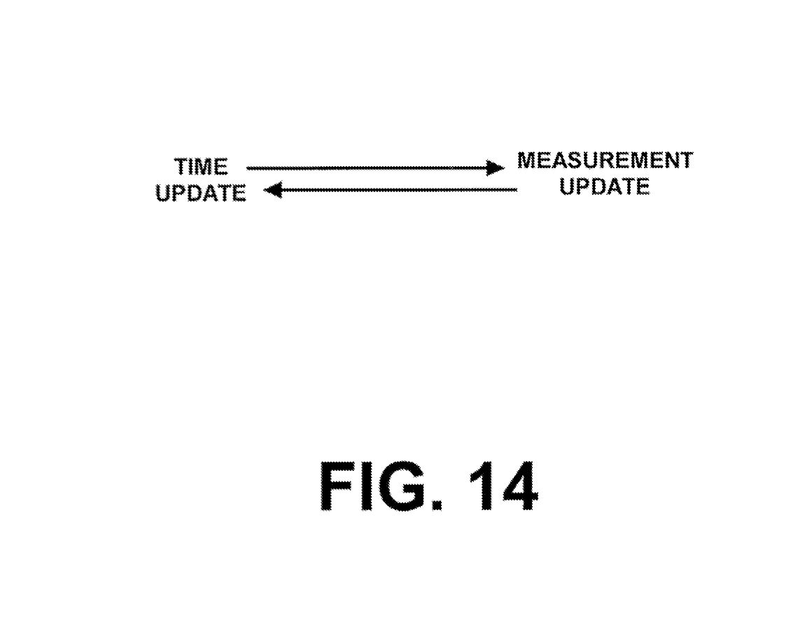

The random variable wₜ and vₜ represent the process and measurement noise, respectively, empirically determined, white, and with normal probability distributions. Referring also to FIG. 14, the Kalman filter may estimate a state by using a form of feedback control: the filter estimates the process state at some time and then obtains feedback in the form of measurements. As such, the equations for the Kalman filter may fall into two groups: time update equations and measurement update equations. The time update equations are for projecting forward (prediction) the current state and error covariance estimates to obtain the a priori estimates for the next time step. The measurement update (correction) equations are for the feedback, i.e., for incorporating a new measurement into the a priori estimate to obtain an improved a posteriori estimate.

The time update relations may be, xₜ=Axₜ₋₁+Buₜ₋₁ and Pₜ=APₜ₋₁A^{T}+Q.

The measurement update relations may be, Kₜ=PₜH^{T}(HPₜH^{T}+R)⁻¹, xₜ=xₜ+Kₜ(zₜ+Hxₜ) , and Pₜ=(I−KₜH)Pₜ. The first task during the measurement update is to compute the Kalman gain, Kₜ. The next step is to measure the process to obtain zₜ, and then to generate an a posteriori state estimate by incorporating the measurement. The next step is to obtain an a posteriori error covariance estimate. After each time and measurement update pair, the process is repeated with the previous a posteriori estimates used to project or predict the new a priori estimates. The estimated eye positions from the Kalman filter may be used to replace the detected eye positions, thereby achieving smoother eye motion trajectories.

Referring again to FIG. 9, the output of the temporal smoothing of the eye position 470 is processed to modify the two dimensional pixel coordinates within the color image to its corresponding three dimensional position within the viewing space 480. For example, the determined eye positions are two dimensional pixel coordinates defined on the captured images of the viewing space. With the two dimensional positions of the eyes, the system may determine the depth of both eyes in the depth map. The returned value z is the distance of the eye to camera center. The camera projection matrix may be,

$$z [ \begin{matrix}u \\ v \\ 1\end{matrix} ] = K [ \begin{matrix}x \\ y \\ z\end{matrix} ] ,$$

where [u v] is the two dimensional coordinate of the eye position, [x y z] is the three dimensional coordinate of the eye with respect to the camera center, and K is the camera intrinsic matrix. Based upon the viewer's eye positions the three dimensional viewing characteristics for the viewer may be improved 490.

Once the viewing zone and viewers' eye positions are determined, the system may determine if the viewers are within a sufficiently optimal viewing zone or not. There are several sources for sub-optimal three dimensional viewing zones, which depending on the source of the limitation, may be reduced by modification of the images or viewer's position provided to one or more viewers.

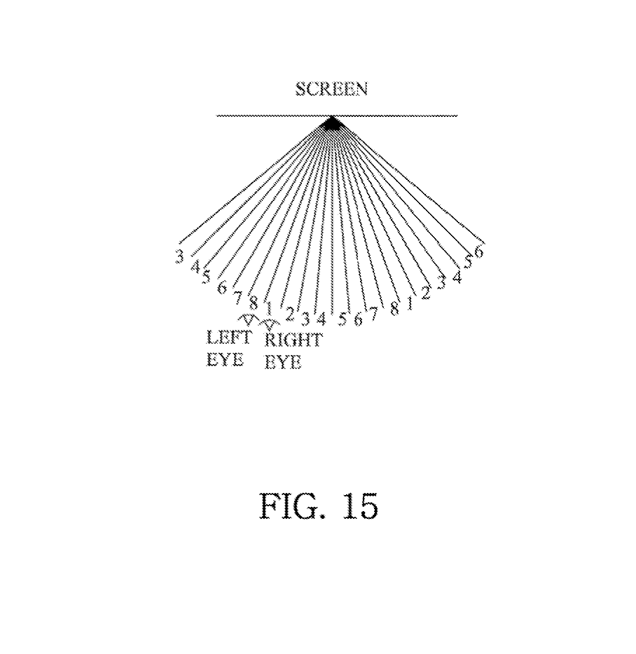

In many cases, the eyes of the viewer are aligned with the left eye observing the left view and the right eye observing the right view. Referring to FIG. 15, in the region of adjoining sets of eight views the left eyes observes the image intended for the right eye and the right eyes observes the image indeed for the left eye. This reversal of images results in visual discomfort and fatigue. For example, if the viewer's left eye sees view #8 and the right eye sees view #1 from an eight view display, the viewer will observe a reversed depth.

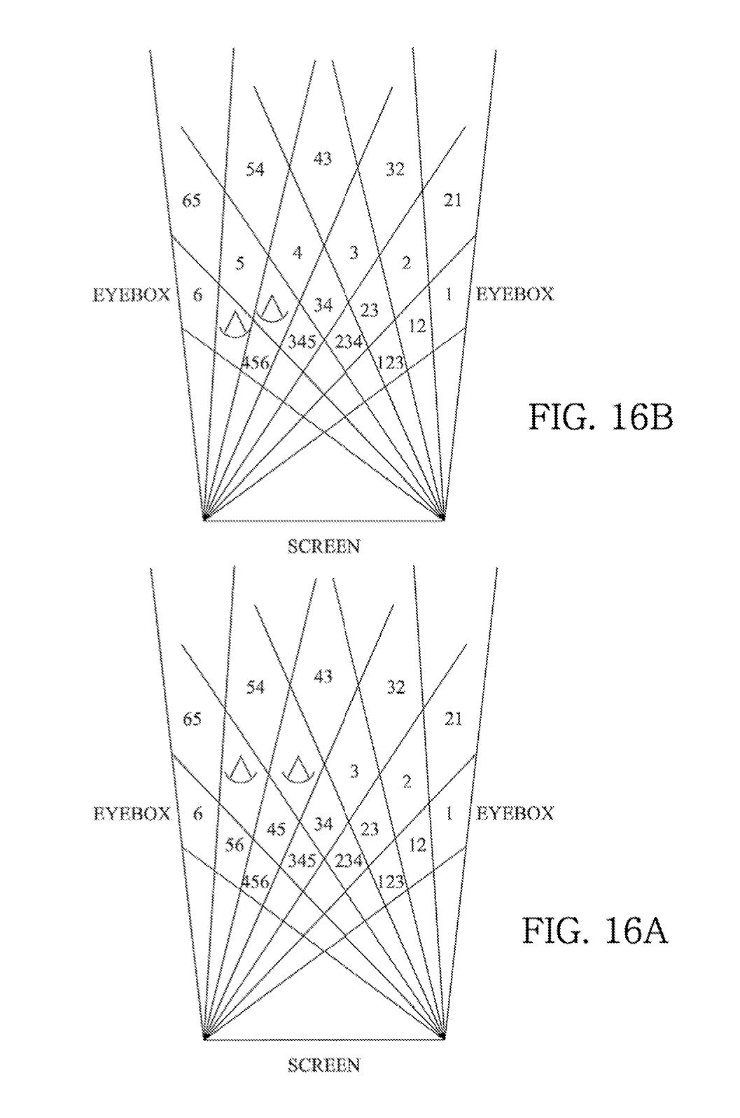

FIG. 16A and FIG. 16B illustrate an example of mixed viewing zones. FIG. 16A shows the situation where each eye only observes one zone intended for that eye, and tends to lead to a preferred three dimensional perception. FIG. 16B shows the situation where each eye observes multiple zones: e.g., the left eye observes zones 4 and 5, and the right eye observes zones 5 and 6. The images observed by the viewer will contain different parts from different views which leads to degraded three dimensional depth perception.

Displays usually generate cross talk between the adjacent views. The cross talk, however, can be spatially varying. For example, the cross talk may be more visible if the three dimensional image is viewed off-angle. If the viewers happen to stand in such positions, they will observe lower-quality images. Cross talk correction processes may be applied to reduce the crosstalk before applying view adjustment techniques.

If one or more viewers are not properly located to view optimal three dimensional images, the auto stereoscopic display will determine a suitable modification to the images and/or direct the viewers to move to a more suitable position.

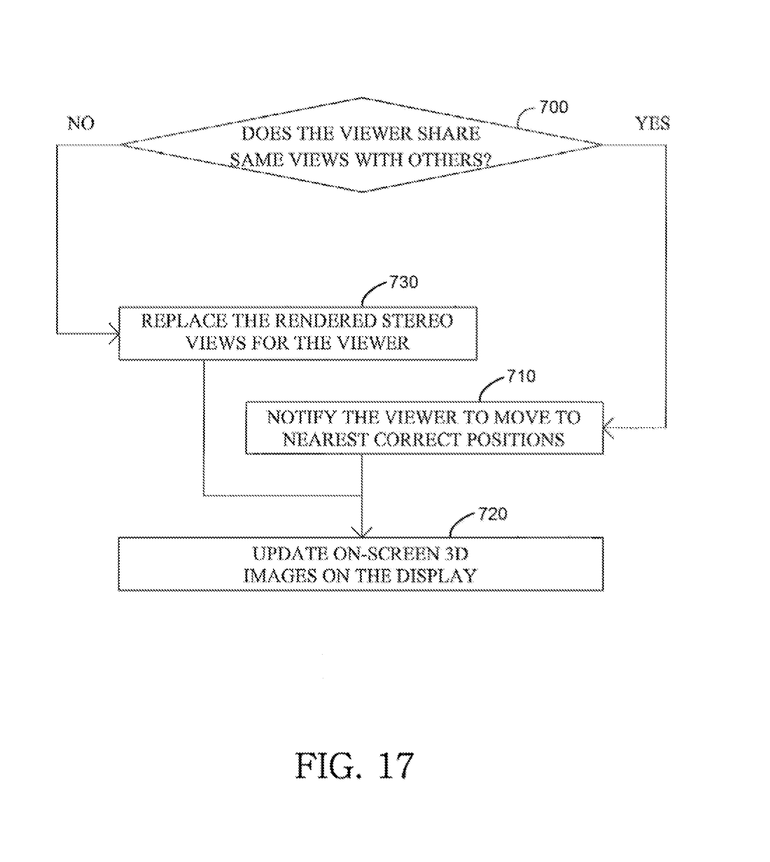

Referring to FIG. 17, the display may determine if one of the same views is shared among multiple viewers 700. In the case that multiple viewers are observing one of the same views, then the display may notify one or more of the viewers to move to another position 710 so as to not share a view.

The display may also determine if one of the same views is shared among multiple viewers. In the case that multiple viewers are observing one of the same viewers, the system may update the on screen three dimensional images on the display 720 by suitably replacing the shared view with different non-shared views to improve the three dimensional viewing characteristics.

In the case that multiple viewers are not observing one of the same views, then the display may replace one or more of the existing views with one or more other views 730 to improve the three dimensional viewing experience for the viewers. In this case, the system may determine which of the views to be replaced with another view in a manner suitable to improve the viewing characteristic for one or more viewers.

In the case that multiple viewers are observing one of the same views, then the display may be capable of replacing the other non-matching view in a manner to improve the three dimensional viewing experience for at least one of the viewers, and preferably all of the viewers.

In the case that multiple viewers are observing one of the same views, then the display may be capable of replacing the matching view in a manner to improve the three dimensional viewing experience for at least one of the viewers, and preferably all of the viewers.

In the case that multiple viewers are observing one of the same views, then the display may be capable of replacing both of the views in a manner to improve the three dimensional viewing experience for at least one of the viewers, and preferably all of the viewers.

The different sources of sub-optimal image quality may result in different image adjustments for a more suitable viewing experience. By way of example, in the case that the views are reversed, the two reversed views may be reversed so that the viewer's eyes see the three dimensional images in the proper left eye and right eye. This is especially suitable when the switching of the two views does not impact any other viewers. By way of example, if a viewer observes reversed views #8 and #1, the system may check if there exist other viewers seeing either of the same two views (#1 and #8). This assists in ensuring that any adjustment to views #1 and #8 do not adversely affect other viewers who are already having optimal three dimensional viewing. If there is no adverse impact on other viewers, the system may switch view #1 with view #8 so that the viewer observes a more optimal three dimensional viewing experience.

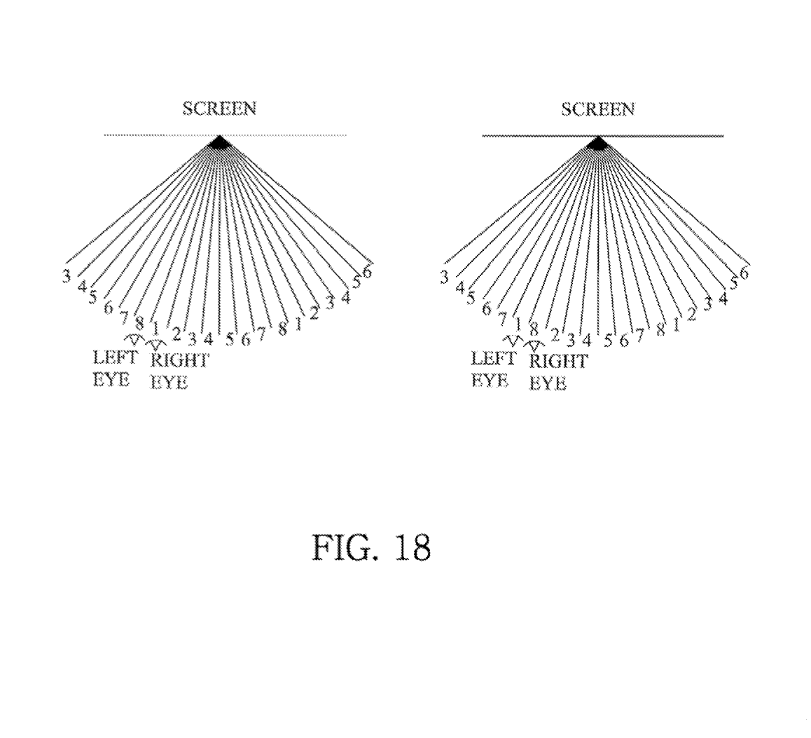

Referring to FIG. 18, the display may temporally switch views #1 and #8 so that the viewer will not see the reversed image. If the viewer moves away from this position, the original views #1 and #8 may be restored to their original arrangement.

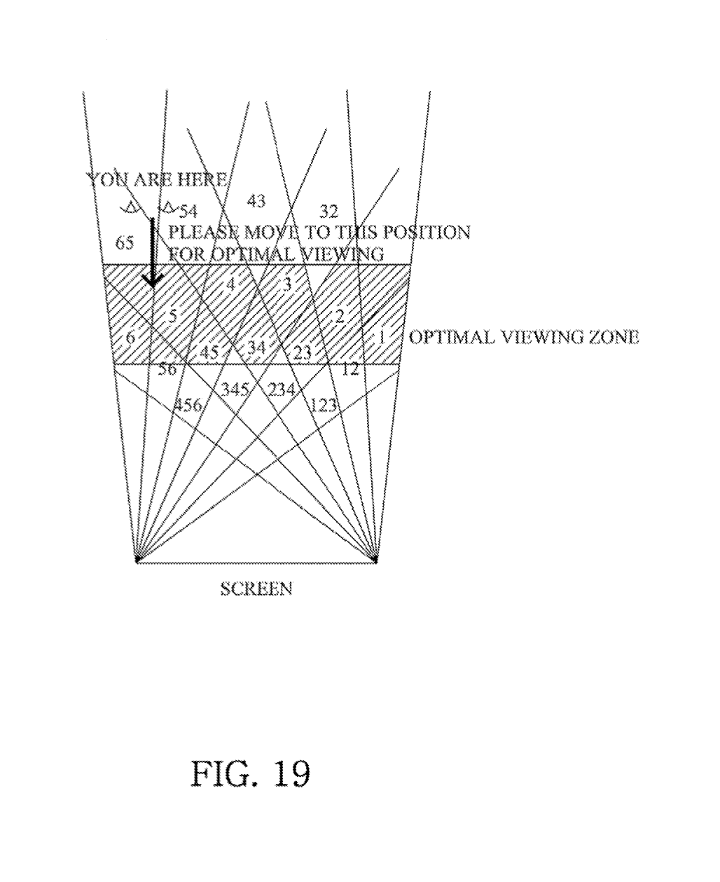

As previously discussed, in the case of a mixed viewing zone situation, the zones that appear to the viewers' eyes may be replaced by a single viewing zone. For example, a zone that includes a plurality of different views may be replaced by a single view. Referring to FIG. 19, by way of example, the viewer originally sees views #45 in his left eye and #56 in his right eye. The system may apply a replacement of the original #3 as new #4, the original #4 as new #5, and the original #4 as new #6. As a result the viewer then observes #3 in his left eye and #4 in his right eye, which improves the three dimensional viewing experience.

In the case of cross talk between adjacent views, cross talk reduction techniques may be applied to reduce the leakage of one view into the adjacent view.

If the viewer with sub-optimal viewing shares the same views with other viewers, the above viewer replacement technique may not be suitable. In this case, the technique may show the current viewing zone with viewers' positions and instructs the viewer to move to a better position.

If the viewer with sub-optimal viewing shares the same views with other viewers, the above viewer replacement technique may not be suitable. In this case, the technique may replace the three dimensional display technique with a two dimensional display.

If the viewer with sub-optimal viewing shares the same views with other viewers, the above viewer replacement technique may not be suitable. In this case, the technique may replace the three dimensional display technique for one or more viewers with a two dimensional display and maintain three dimensional display for other viewers. In this manner, the display may have a mixed mode two dimensional and three dimensional content simultaneously presented to a plurality of viewers.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. An auto stereoscopic display comprising:
(a) said auto stereoscopic display including a plurality of views thereby providing a perceived three dimensional image to a viewer;
(b) said display including a sensor that determines the position of the head of said viewer with respect to said display;
(c) modifying said plurality of views to provide an improved said perceived three dimensional image to said viewer based upon said position of said head.

2. The display of claim 1 wherein said determining said position of said head of said viewer is based upon a plurality of frames of images from said sensor.

3. The display of claim 2 wherein said position of said head is tracked across each of said plurality of frames.

4. The display of claim 3 wherein said position of said head is tracked using a skeleton structure.

5. The display of claim 4 wherein said skeleton structure includes a plurality of points connected by lines.

6. The display of claim 5 wherein said position of said skeleton structure of said head is projected onto a two dimensional color image of a viewing space.

7. The display of claim 6 wherein a bounding box is used to define a region of said two dimensional color image.

8. The display of claim 7 wherein said bounding box is used to determine a distance of a viewer from said display.

9. The display of claim 1 wherein said determining said position of said head of said viewer is based upon a Haar-like feature detection process.

10. The display of claim 1 wherein said determining said position of said head of said viewer is based a determination of whether a pair of eyes are determined within a frame.

11. The display of claim 1 wherein said determining said position of said head of said viewer is based upon face matching when both eyes are not otherwise detected.

12. The display of claim 1 wherein said sensor obtains a two dimensional color image.

13. The display of claim 1 wherein said sensor obtains a three dimensional image.

14. The display of claim 1 wherein said sensor obtains both a two dimensional color image and a three dimensional image.

15. The display of claim 1 including presenting an image to said viewer indicating a desirability to relocate based upon said sensing said position of said viewer.

16. The display of claim 1 wherein said sensor determines a position of a plurality of viewers with respect to said display.

17. The display of claim 16 wherein said display modifies said plurality of views to provide an improved said perceived three dimensional image to a plurality of said viewers.
